(19) United States
(12) Patent Application Publication
(10) Pub. No.: US 2010/0049784 A1
(43) Pub. Date: Feb. 25, 2010

(54) SYSTEM AND METHOD FOR WEB-BASED ACCESS RELATIVE TO A DOCUMENT PROCESSING DEVICE

(76) Inventors: Ashish Khandelwal, Aliso Viejo, CA (US); Sameer Yami, Irvine, CA (US); Amir Shahindoust, Laguna Niguel, CA (US); Michael L. Yeung, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/195,784

(22) Filed: Aug. 21, 2008

(51) Int. Cl. G06F 15/16

(52) U.S. Cl. 709/203

(57) ABSTRACT

The subject application is directed to a security system and method for web-based access relative to a document processing device. Safe site data corresponding to a plurality of acceptable data addresses is stored in a data storage. A plurality of web pages is generated via an associated web server. Each address referenced within each of the plurality of web pages is identified and tested against the safe site data. An alarm is generated when an output of the testing indicates at least one identified address that is not associated with safe site data in accordance with an output of the testing. The web page output is enabled by the web server to a thin client when an output of the testing indicates that each identified address is associated with safe data.

### BACKGROUND OF THE INVENTION

The subject application is directed generally to security of web servers. The application is particularly applicable to security for web servers associated with document processing devices.

Web servers are in wide use for disseminating data and typically operate by communicating web pages via interaction with thin clients such as remote networked workstations operating a web browser. A great variety exists relative to the type of data that is transmittable via a web server/thin client communication session. Such sessions include queries for information, communication of catalog information for marketing or sales, transmission of electronic documents, transmission of media content, or the like. Web sessions are also now commonly used for control of devices, either remotely or via direct connection or integration with a device to be controlled.

Given the flexibility and utility of web-based interfaces, they have more recently been engrafted into devices such as document processing devices. Document processing devices include printers, scanners, facsimile machines, copiers, and the like. More recently, more than one such function is included with a device, which is referred to as a multifunction peripheral (MFP) or multifunction device (MFD). With such devices, a web server/thin client interface suitably allows for transmission of electronic documents, machine control, machine status reporting, job status reporting, and the like.

One drawback of web-based interaction is that it provides an opportunity for entry of malicious code into a device environment or redirection to another device without the knowledge of an end user.

### SUMMARY OF THE INVENTION

In accordance with one embodiment of the subject application, there is provided a web-based access relative to a document processing device. Safe site data corresponding to a plurality of acceptable data addresses is stored in a data storage. A plurality of web pages are generated via an associated web server. Each address referenced within each of the plurality of web pages is identified and tested against the safe site data. An alarm is generated when an output of the testing indicates that at least one identified address is not associated with safe site data in accordance with an output of the testing. The web page output is enabled by the web server to a thin client when an output of the testing indicates that each identified address is associated with safe data in accordance.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a security system for web-based access relative to a document processing device according to one embodiment of the subject application;

FIG. 2 is a block diagram illustrating device hardware for use in the security system for web-based access relative to a document processing device according to one embodiment of the subject application;

FIG. 3 is a functional diagram illustrating the device for use in the security system for web-based access relative to a document processing device according to one embodiment of the subject application;

FIG. 4 is a block diagram illustrating controller hardware for use in the security system for web-based access relative to a document processing device according to one embodiment of the subject application;

FIG. 5 is a functional diagram illustrating the controller for use in the security system for web-based access relative to a document processing device according to one embodiment of the subject application;

FIG. 6 is a block diagram illustrating the security system for web-based access relative to a document processing device according to one embodiment of the subject application;

FIG. 7 is a functional diagram illustrating the security system for web-based access relative to a document processing device according to one embodiment of the subject application;

FIG. 8 is a flowchart illustrating a security method for web-based access relative to a document processing device according to one embodiment of the subject application; and

FIG. 9 is a flowchart illustrating a security method for web-based access relative to a document processing device according to one embodiment of the subject application.

### DETAILED DESCRIPTION OF THE PREFERRED EMBODIMENT

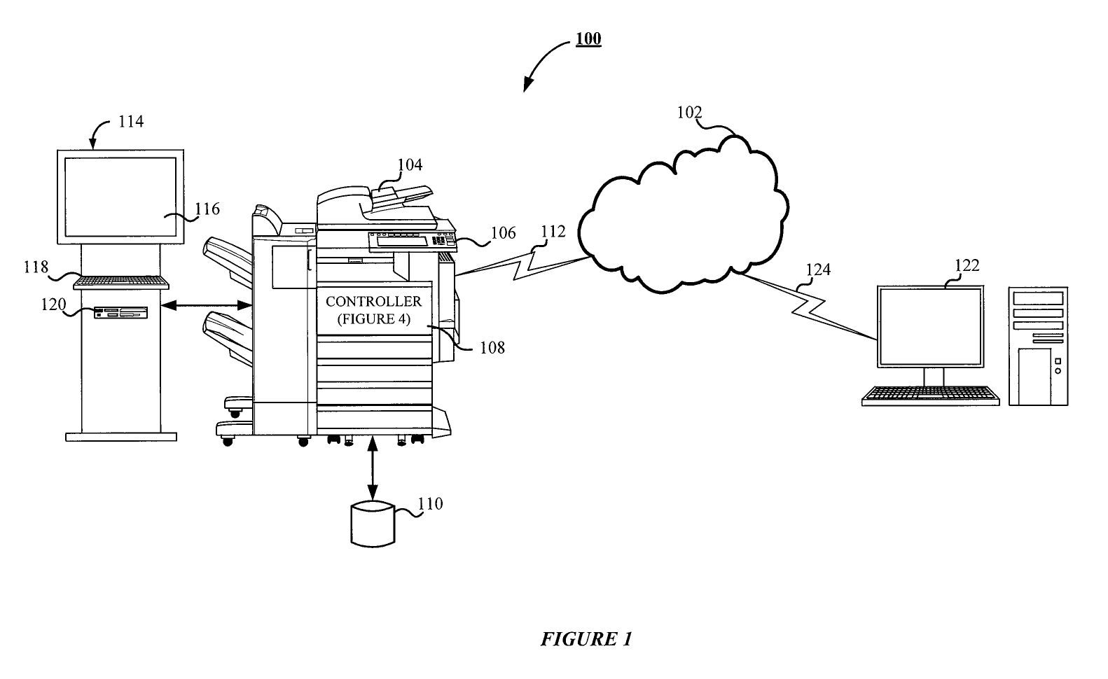

The subject application is directed to a system and method for security of web servers. In particular, the subject application is directed to a system and method for security of web servers associated with document processing devices. It will become apparent to those skilled in the art that the system and method described herein are suitably adapted to a plurality of varying electronic fields employing device security including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a security system 100 for web-based access relative to a document processing device in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, which is depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

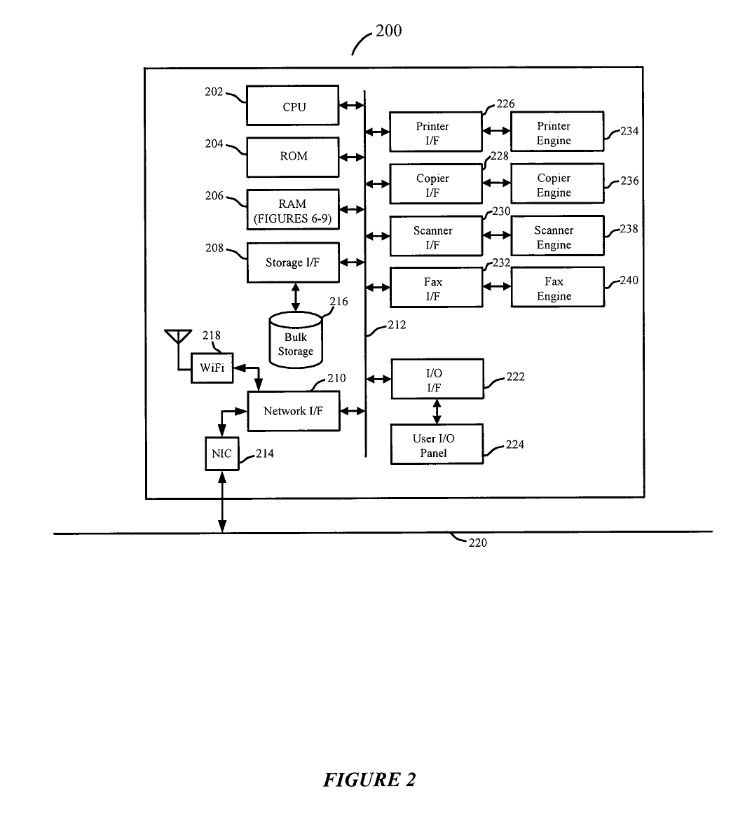

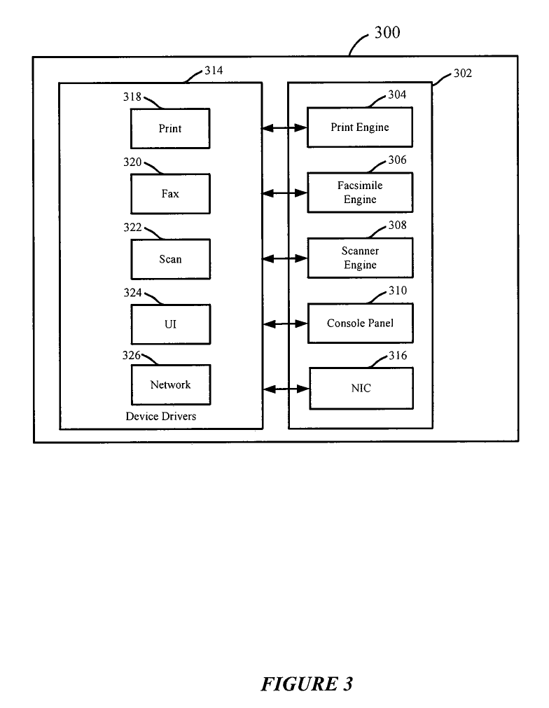

According to one embodiment of the subject application, the document processing device 104 is suitably equipped to receive a plurality of portable storage media including, without limitation, Firewire drive, USB drive, SD, MMC, XD, compact flash, memory stick, and the like. In the preferred embodiment of the subject application, the document processing device 104 further includes an associated user interface 106, such as a touch screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, to receive input from the associated user, and to communicate the same to a backend component such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

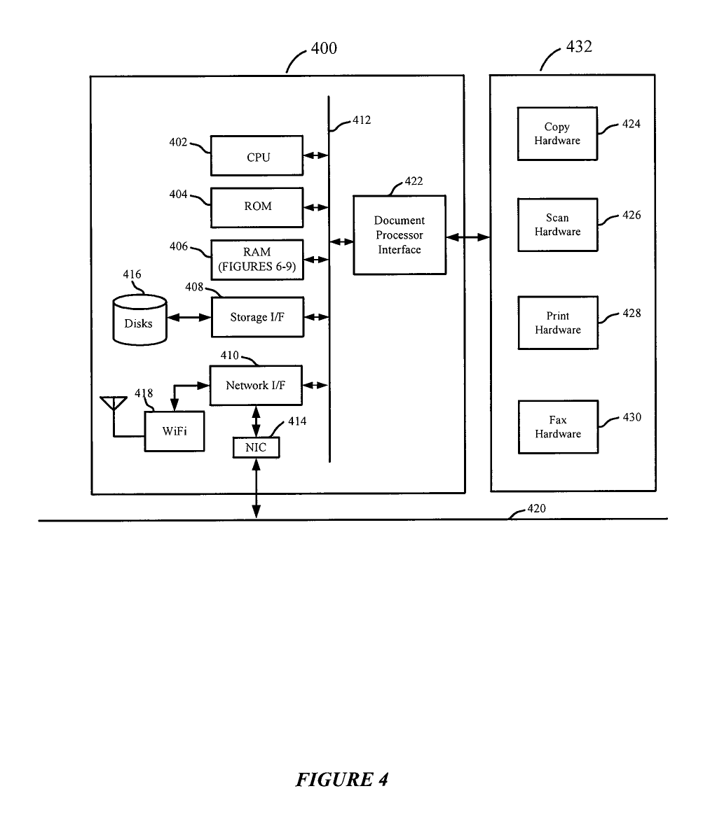

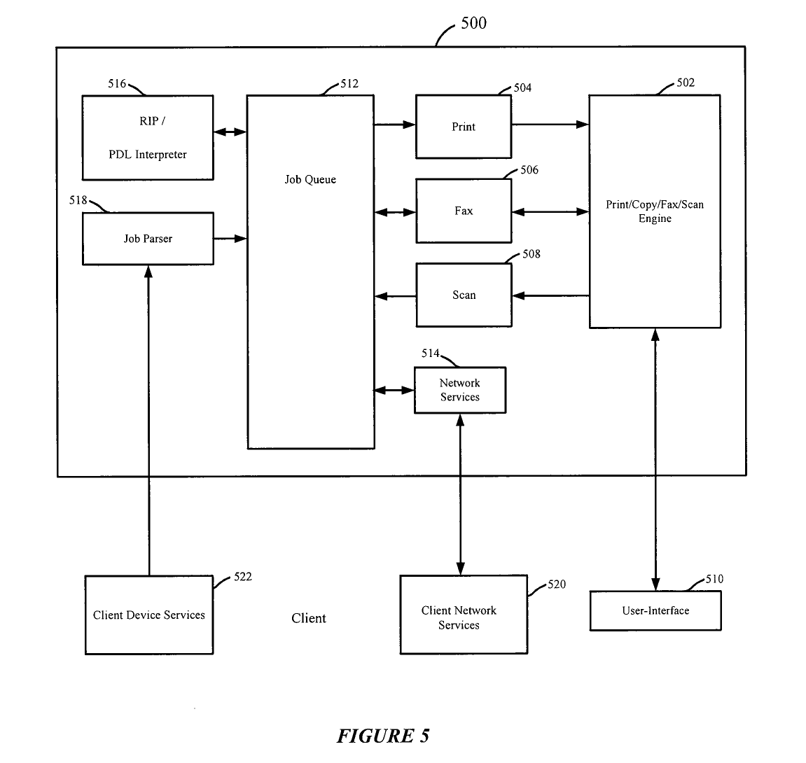

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the security system and method for web-based access relative to a document processing device. The functioning of the controller 108 will be better understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, hard disk drives, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document processing device 104 and, in effect, the computer network 102. It will be appreciated by those skilled in the art that the kiosk 114 is capable of being implemented as a separate component of the document processing device 104 or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116 and a user input device 118. As will be understood by those skilled in the art, the kiosk 114 is capable of implementing a combination user input device/display, such as a touch screen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like suitably adapted to receive and read payment data from a credit card, coupon, debit card, or the like.

The system 100 of FIG. 1 also includes a portable storage device reader 120 coupled to the kiosk 114 that is suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Depicted in FIG. 1 is an administrative device 122, illustrated as a personal computer in data communication with the computer network 102 via a communications link 124. It will be appreciated by those skilled in the art that the administrative device 122 is shown in FIG. 1 as a computer workstation for illustration purposes only. As will be understood by those skilled in the art, the administrative device 122 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 124 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative device 122 is suitably adapted to receive redacted documents, status data, job data, user interface data, and/or image data; to monitor document processing jobs; to employ thin-client interfaces; to generate display data; to generate output data; or the like with respect to the document processing device 104 or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316, with a network via driver 326, suitably comprised of a network interface card. It will be appreciated that a network thoroughly accomplishes that interchange via any suitable physical or non-physical layer such as wired, wireless, or optical data communication.

The document processing engine 302 is suitably in data communication with one or more device drivers 314, which device drivers 314 allow for data interchange from the document processing engine 302 to one or more physical devices so as to accomplish the actual document processing operations. Such document processing operations include one or more of printing via driver 318, facsimile communication via driver 320, scanning via driver 322, and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 so as to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

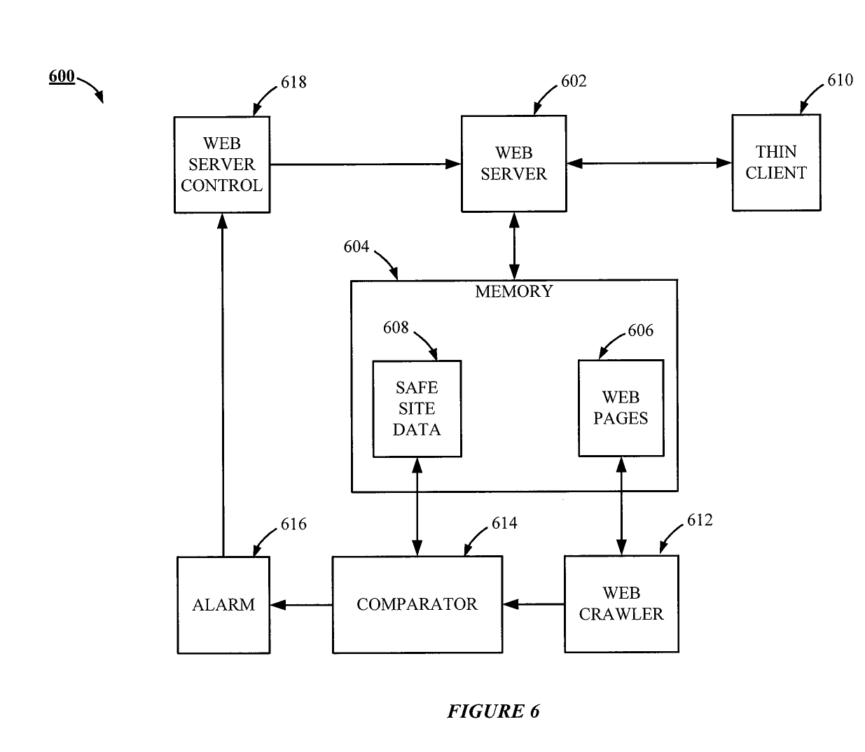

Turning now to FIG. 6, illustrated is a block diagram of a security system 600 for web-based access relative to a document processing device in accordance with one embodiment of the subject application. The system 600 includes a web server 602 in data communication with a memory 604. The memory 604 stores web pages 606, each of which includes data corresponding to at least one data address, and safe site data 608 corresponding to acceptable data addresses. The system 600 also includes a thin client 610 in data communication with the web server 602 and a web crawler 612 operable on the web pages 606. According to one embodiment of the subject application, the web crawler 612 is suitably configured to identify addresses associated with the web pages 606. A comparator 614 then compares the addresses identified by the web crawler 612 with the safe site data 608 so as to determine whether at least one of the identified addresses is not associated with the safe site data 608. The system 600 further includes an alarm 616 that is operable when the comparator 614 indicates that an output of the web crawler 612 is not connected with the safe site data 608. A web server control 618 is also included in the system 600, which control 618 is operable in accordance with the alarm 616. In accordance with one embodiment of the subject application, the web server control 618 directs the web server 602 based upon the output of the alarm 616, e.g. restrict access to the non-associated web page. Furthermore, when the alarm 616 does not output an indication that a non-associated web page has been identified by the web crawler 612, normal operations of the web server 602 are suitably enabled by the web server control 618.

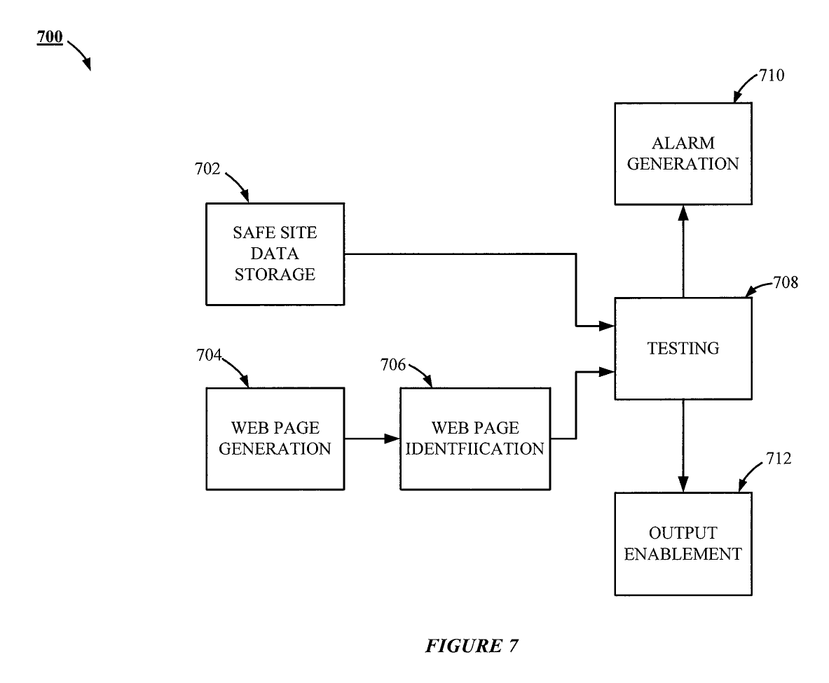

Referring now to FIG. 7, there is shown a functional diagram 700 illustrating the security system for web-based access relative to a document processing device, in accordance with one embodiment of the subject application. Safe site data storage 702 first occurs, corresponding to the storage of safe site data representing a plurality of acceptable data addresses. Web page generation 704 is then performed for a plurality of web pages via an associated web server. Web page identification 706 is obtained for each address referenced within each of the web pages. Testing 708 is then performed between each result of the web page identification 706 and the safe site data storage 702. Alarm generation 710 occurs upon a result of the testing 708 indicating that at least one identified address of the page identification 706 is not associated with a safe site of the safe site data storage 702. Output enablement 712 occurs for the server to a thin client when the testing 708 indicates that the results of the web page identification 706 are each associated with safe site data in the safe site data storage 702.

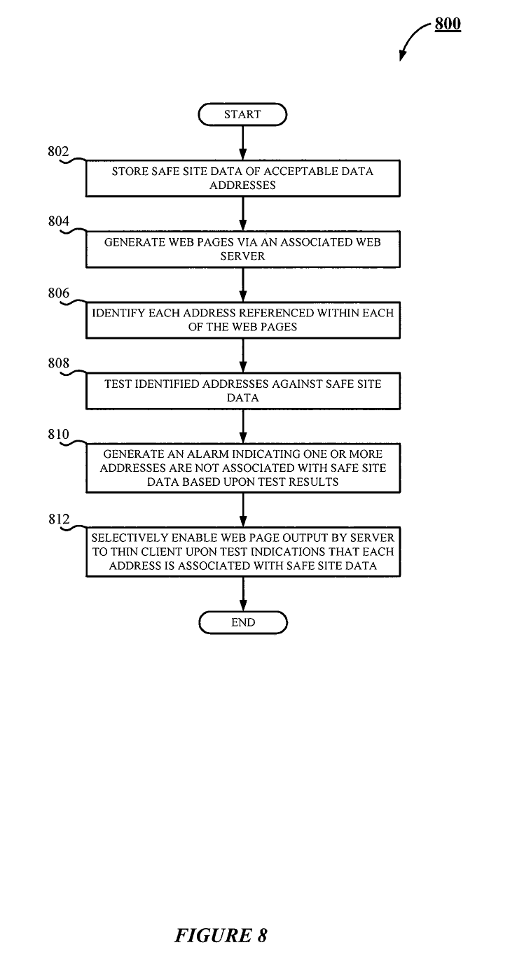

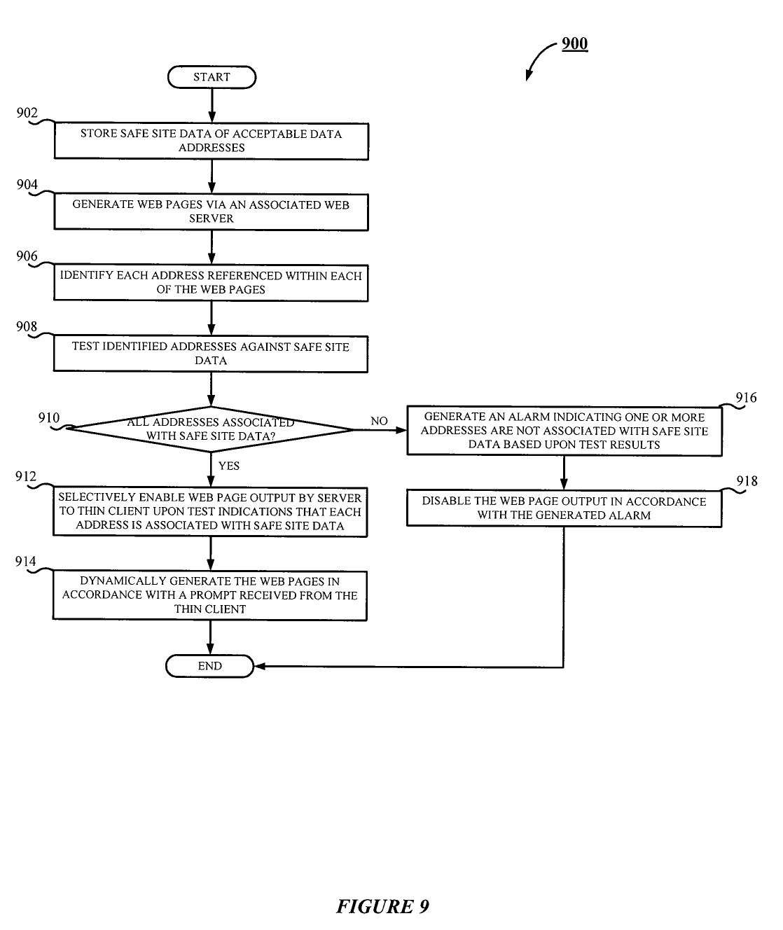

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a security method for web-based access relative to a document processing device in accordance with one embodiment of the subject application. Beginning at step 802, safe site data is stored in the data storage 110 corresponding to a plurality of acceptable data addresses. At step 804, a plurality of web pages are generated via an associated web server. In accordance with one embodiment of the subject application, the controller 108 or other suitable component associated with the document processing device 104 is configured to function as a web server in accordance with the methodology of FIG. 8. The skilled artisan will appreciate that such a function is also capable of being undertaken by any such device in data communication with the document processing device 104 including, for example and without limitation, the kiosk 114, the administrative device 122, and the like.

At step 806, the controller 108 or other suitable component associated with the document processing device 104 identifies each addresses referenced with each of the web pages generated by the web server. The identified addresses are then tested at step 808 against the safe site data so as to determine whether the web page addresses of each page are associated with the safe site data. At step 810, an alarm is generated by the controller 108 or other such component associated with the document processing device 104 when the testing at step 808 indicates that at least one of the identified addresses is not associated with the safe site data; that is, a notification is communicated to the administrative device 122, the user associated with the kiosk 114, user interface 106, or the like indicating that one of the web pages generated by the web server functionality of the device 104 does not correspond to a safe site, e.g. an unrecognized web address or the like. At step 812, the web page output is selectively enabled by the web server to a thin client when the testing output indicates that each identified address is associated with safe site data. Stated another way, when the controller 108 determines that each of the identified addresses corresponds to safe site data, the controller 108 or other such web server selectively enables the output of such web pages to a thin client, e.g. web browser on the user interface 106, the kiosk 114, or the like.

Referring now to FIG. 9, there is shown a flowchart 900 illustrating a security method for web-based access relative to a document processing device, in accordance with one embodiment of the subject application. The methodology of FIG. 9 begins at step 902, whereupon safe site data of acceptable data addresses, e.g. uniform resource locator, internet protocol address, or the like, is first stored in memory associated with the document processing device 104, e.g. the data storage device 110. It will be appreciated by those skilled in the art that such safe site data is capable of being received by the document processing device 104 from the administrative device 122, from administrative interaction via the user interface 106 or the kiosk 114, or the like.

At step 904, web pages are generated via an associated web server, with each web page including at least one data address. It will be understood by those skilled in the art that the controller 108 or other suitable component associated with the document processing device 104 functions as a web server, generating each web page from data stored in the associated data storage device 110. According to one embodiment of the subject application, the data address includes a web address, a memory address, or the like. A web crawler or other similar component is then implemented by the controller 108 to identify each address referenced within the web pages at step 906. In accordance with one embodiment of the subject application, the identification of each address is enabled on the web pages upon the startup of the document processing device 104. The controller 108 or other suitable component associated with the document processing device 104 then tests the identified addresses against the stored safe site data at step 908.

A determination is then made at step 910 as to whether all the addresses identified from the web pages are associated with the safe site data; that is, the controller 108 or other suitable component associated with the document processing device 104 compares each of the identified addresses against the addresses designated as safe sites (known addresses). Upon a determination at step 910 that all addresses correspond to safe sites, flow proceeds to step 912. At step 912, the controller 108, functioning as the web server, selectively enables web page output to a thin client. It will be appreciated by those skilled in the art that such a thin client includes, for example and without limitation, a web browser or similar interface displayed on the user interface 106, the kiosk 114, or the like. Thereafter, at step 914 the web pages are dynamically generated by the controller 108 functioning as the web server in accordance with a prompt received via the thin client, e.g. user input via the user interface 106, the kiosk 114, or the like.

When it is determined at step 910 that one or more of the identified addresses do not correspond to stored safe sites, flow proceeds to step 916. At step 916, an alarm is generated by the controller 108 or other suitable component associated with the document processing device 104 indicating one or more compromised, unsafe, or unknown addresses. According to one embodiment of the subject application, such an alarm is communicated to an associated user via the user interface 106, the kiosk 114, or the like. In accordance with another embodiment of the subject application, an alarm is generated via the administrative device 122 so as to indicate to an administrator the presence of an unknown, unsafe, or compromised web site on the document processing device 104. Web page output by the controller 108 or other suitable component associated with the document processing device 104 functioning as the web server is then selectively disabled at step 918 based upon the alarm output.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application, to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A security system for web-based access relative to a document processing device, comprising:
a web server;
a memory including data storage for a plurality of web pages, each web page including data corresponding to at least one data address;
the memory further including data storage for safe site data corresponding to a plurality of acceptable data addresses;
a thin client in data communication with the web server;
a web crawler operable on the web pages;
a comparator between addresses identified by the web crawler and safe site data;
an alarm operable when the comparator indicates an output of the web crawler is not connected with safe site data; and
a web server control operable in accordance with the alarm.

2. The system of claim 1, further comprising a system start sensor and wherein the crawler is operable in accordance with an output of the system start sensor.

3. The system of claim 1, further comprising the memory including data corresponding to at least one of a data storage location and a network address.

4. The system of claim 1, further comprising a dynamic web page generator operable on instructions from the thin client.

5. A security method for web-based access relative to a document processing device, comprising:
storing safe site data corresponding to a plurality of acceptable data addresses in a data storage;
generating a plurality of web pages via an associated web server;
identifying each address referenced within each of the plurality of web pages;
testing each identified address against the safe site data;
generating an alarm when an output of the testing indicates at least one identified address that is not associated with safe site data; and
selectively enabling the web page output by the web server to a thin client when an output of the testing indicates that each identified address is associated with safe data.

6. The method of claim 5, further comprising the step of dynamically generating the web pages in accordance with a prompt received from the thin client.

7. The method of claim 5, wherein the address data includes at least one of a web address and a memory address.

8. The method of claim 7, wherein the step of identifying each address is enabled on the web pages upon startup of an associated document processing device.

9. The method of claim 5, further comprising the step of disabling the web page output in accordance with a generated alarm.

10. A security system for web-based access relative to a document processing device, comprising:
a web page output adapted for outputting web pages to a thin client;
a data storage adapted for storing safe site data corresponding to a plurality of acceptable data addresses;
means adapted for generating a plurality of web pages;
crawler means adapted for identifying each address referenced within each of the plurality of web pages;
testing means adapted for testing each identified address against the safe site data;
means adapted for generating an alarm when an output of the testing means indicates at least one identified address that is not associated with safe site data; and
means adapted for selectively enabling the web page output to the thin client when an output of the testing means indicates that each identified address is associated with safe data.

11. The system of claim 10, further comprising means adapted for dynamically generating the web pages in accordance with a prompt received from the thin client.

12. The system of claim 10, wherein the address data includes at least one of a web address and a memory address.

13. The system of claim 12, wherein the crawler means is enabled on the web pages upon startup of an associated document processing device.

14. The system of claim 10, further comprising means adapted for disabling the web page output in accordance with a generated alarm.
